(19) United States
(12) Patent Application Publication
(10) Pub. No.: US 2024/0304363 A1
(43) Pub. Date: Sep. 12, 2024

(54) ELECTRONIC COMPONENT

(71) Applicant: Murata Manufacturing Co., Ltd., Nagaokakyo-shi (JP)

(72) Inventors: Tomoya OOSHIMA, Nagaokakyo-shi (JP); Yuuta HOSHINO, Nagaokakyo-shi (JP); Koichi YAMADA, Nagaokakyo-shi (JP); Kojiro TOKIEDA, Nagaokakyo-shi (JP); Miki SASAKI, Nagaokakyo-shi (JP)

(21) Appl. No.: 18/667,780

(22) Filed: May 17, 2024

Related U.S. Application Data
(63) Continuation of application No. PCT/JP2023/024562, filed on Jul. 3, 2023.

(30) Foreign Application Priority Data
Oct. 28, 2022 (JP) 2022-173538

(51) Int. Cl. H01C 7/04; H01C 1/148; H01G 4/008; H01G 4/012; H01G 4/30

(52) U.S. Cl. CPC H01C 7/044; H01C 1/148; H01G 4/008; H01G 4/012; H01G 4/30

(57) ABSTRACT

An electronic component that includes: a base body; a glass film covering an outer surface of the base body; and an external electrode on an outer surface of the glass film and having at least an underlayer electrode, wherein the glass film includes: a base portion containing silicon oxide and an oxide of one or more metal elements of an alkali metal and an alkaline earth metal; and a specific portion containing silicon oxide and an oxide of a same metal element as that of the base portion, and wherein a content ratio of the same metal element in the specific portion is smaller than a content ratio of the one or more metal elements in the base portion.

### CROSS REFERENCE TO RELATED APPLICATIONS

The present application is a continuation of International application No. PCT/JP2023/024562, filed Jul. 3, 2023, which claims priority to Japanese Patent Application No. 2022-173538, filed Oct. 28, 2022, the entire contents of each of which are incorporated herein by reference.

### TECHNICAL FIELD

The present description relates to an electronic component.

### BACKGROUND ART

Patent Document 1 describes an electronic component. The electronic component includes a base body and an external electrode stacked on the surface of the base body. The external electrode is formed by firing a conductive paste. The conductive paste contains a conductive powder, a borosilicate-based glass, a silica powder, and an organic vehicle.
Patent Document 1: Japanese Patent No. 5765041

### SUMMARY OF THE DESCRIPTION

The electronic component described in Patent Document 1 contains a silica powder in the external electrode. Therefore, it is possible to have an improved resistance to a water-soluble flux, which is a surface treatment agent during soldering, that is, so-called flux resistance. On the other hand, in the electronic component described in Patent Document 1, the conductive paste contains a silica powder at a high concentration, and therefore has a high melting point. Therefore, cracks are likely to occur in the base body or the like when the conductive paste is fired. Therefore, there is also a limitation in increasing the amount of a silica powder, and a technique capable of improving flux resistance is required other than adding a silica powder.

In order to solve the problems, an embodiment of the present disclosure is an electronic component including: a base body; a glass film covering an outer surface of the base body; and an external electrode on an outer surface of the glass film and having at least an underlayer electrode, wherein the glass film includes: a base portion containing silicon oxide and an oxide of one or more metal elements of an alkali metal and an alkaline earth metal; and a specific portion containing silicon oxide and an oxide of a same metal element as that of the base portion, and wherein a content ratio of the same metal element in the specific portion is smaller than a content ratio of the one or more metal elements in the base portion.

According to the configuration, an interface can be present between the base portion and the specific portion in the glass film. When an interface is present also in the glass film as described above, a water-soluble flux infiltrating into the glass film extends on the interface, but is less likely to penetrate deeper than the interface. Therefore, erosion from the outside to the base body can be further prevented.

The flux resistance can be improved.

### BRIEF EXPLANATION OF THE DRAWINGS

FIG. 1 is a perspective view of an electronic component according to an embodiment.

FIG. 2 is a side view of an electronic component according to an embodiment.

FIG. 3 is a sectional view taken along the line 3-3 in FIG. 2.

FIG. 4 is an enlarged sectional view of a portion including a glass film in FIG. 3.

FIG. 5 is a flowchart to outline a method of manufacturing an electronic component.

FIG. 6 is an explanatory diagram illustrating a method of manufacturing an electronic component.

FIG. 7 is an explanatory diagram illustrating a method of manufacturing an electronic component.

FIG. 8 is an explanatory diagram illustrating a method of manufacturing an electronic component.

FIG. 9 is an explanatory diagram illustrating a method of manufacturing an electronic component.

FIG. 10 is an explanatory diagram illustrating a method of manufacturing an electronic component.

FIG. 11 is an explanatory diagram illustrating a method of manufacturing an electronic component.

FIG. 12 is an enlarged sectional view of a portion including a glass film in an electronic component according to a modification.

### DESCRIPTION OF THE PREFERRED EMBODIMENTS

### Embodiment

Hereinafter, an embodiment of the electronic component will be described with reference to the drawings. In the drawings, sometimes a component is illustrated while enlarged for the sake of easy understanding. In some cases, the dimension ratio of a component differs from an actual dimension ratio or a dimension ratio in another drawing.

### <Schematic Configuration of Electronic Component>

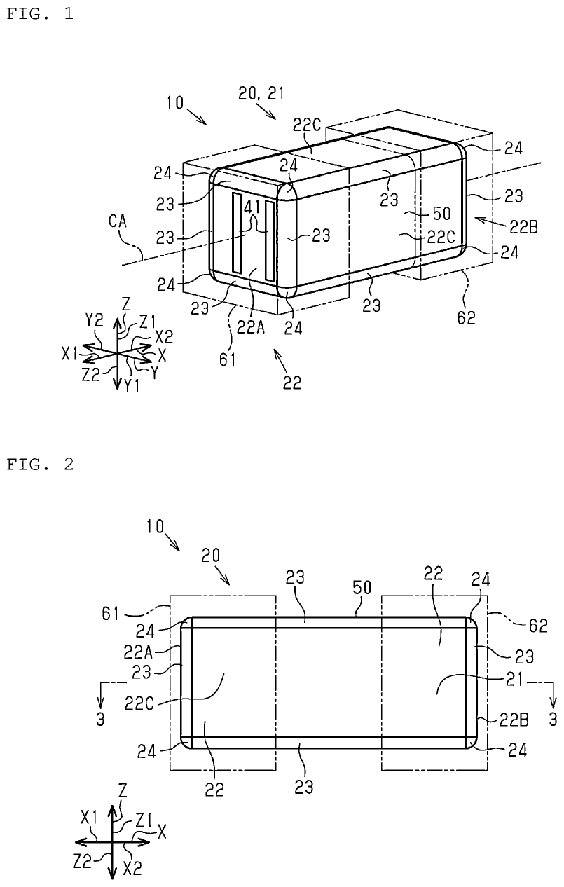

As shown in FIG. 1, an electronic component 10 is, for example, a surface mount negative characteristic thermistor component to be mounted on a circuit board or the like. The negative characteristic thermistor component has a characteristic that the resistance value decreases as the temperature increases.

The electronic component 10 includes a base body 20. The base body 20 has a substantially quadrangular prism shape and has a central axis CA. Hereinafter, the axis extending along the central axis CA is defined as a first axis X. One of the axes orthogonal to the first axis X is defined as a second axis Y. The axis orthogonal to both the first axis X and the second axis Y is defined as a third axis Z. In addition, one of the directions along the first axis X is defined as a first positive direction X1, and the direction opposite to the first positive direction X1 of the directions along the first axis X is defined as a first negative direction X2. One of the directions along the second axis Y is defined as a second positive direction Y1, and the direction opposite to the second positive direction Y1 of the directions along the second axis Y is defined as a second negative direction Y2. In addition, one of the directions along the third axis Z is defined as a third positive direction Z1, and the direction opposite to the third positive direction Z1 of the directions along the third axis Z is defined as a third negative direction Z2.

The outer surface 21 of the base body 20 has six planar surfaces 22. The term “surface” of the base body 20 as used herein refers to a part that can be observed as a surface when the entire base body 20 is observed. That is, for example, if there are minute irregularities or steps that cannot be found unless a part of the base body 20 is enlarged and observed with a microscope or the like, the surface is expressed as a planar surface or a curved surface. The six planar surfaces 22 extend in directions different from each other. The six planar surfaces 22 are roughly divided into a first end surface 22A facing the first positive direction X1, a second end surface 22B facing the first negative direction X2, and four side surfaces 22C. The four side surfaces 22C are a surface facing the third positive direction 21, a surface facing the third negative direction Z2, a surface facing the second positive direction Y1, and a surface facing the second negative direction Y2, respectively.

The outer surface 21 of the base body 20 has twelve boundary surfaces 23. The boundary surface 23 includes a curved surface existing at a boundary between the adjacent planar surfaces 22. That is, the boundary surface 23 includes, for example, a curved surface formed by round chamfering a corner formed by adjacent planar surfaces 22.

The outer surface 21 of the base body 20 has eight spherical corner surfaces 24. The corner surface 24 is a boundary part between three adjacent planar surfaces 22. In other words, the corner surface 24 includes a curved surface at a position where three boundary surfaces 23 intersect. That is, the corner surface 24 includes, for example, a curved surface formed by round chamfering a corner formed by three adjacent planar surfaces 22.

In FIGS. 1 and 2, the surface of a glass film 50 to be described later is designated by the same reference numeral as the outer surface 21 of the base body 20.

As illustrated in FIG. 2, in the base body 20, the dimension in the direction along the first axis X is larger than the dimension in the direction along the third axis Z. Furthermore, as illustrated in FIG. 1, in the base body 20, the dimension in the direction along the first axis X is larger than the dimension in the direction along the second axis Y. The material of the base body 20 is a ceramic obtained by firing a metal oxide containing at least one of Mn, Fe, Ni, Co, Ti, Ba, Al, and Zn as a component.

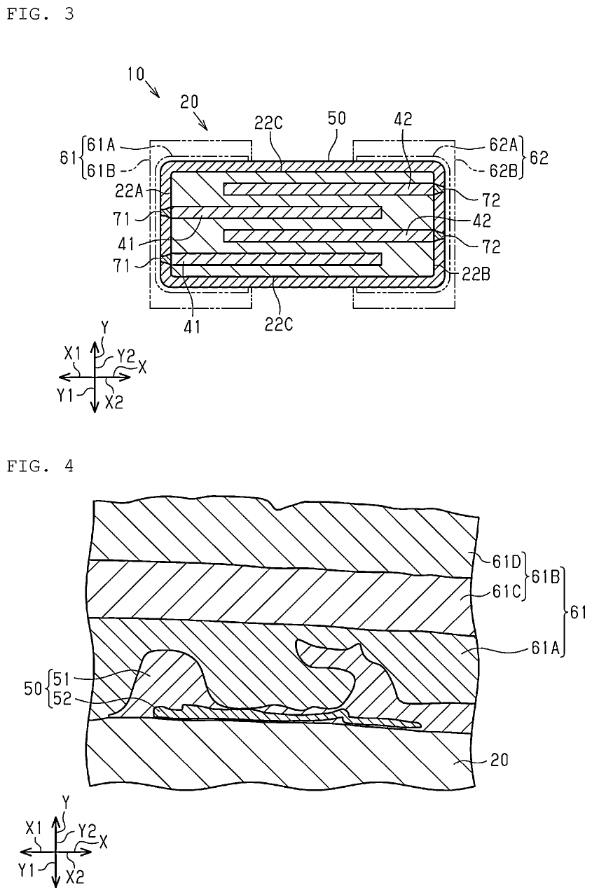

As illustrated in FIG. 3, the electronic component 10 includes two first internal electrodes 41 and two second internal electrodes 42. The first internal electrodes 41 and the second internal electrodes 42 are embedded in the base body 20.

The material of the first internal electrode 41 is a conductive material. For example, the material of the first internal electrode 41 is silver and palladium. The material of the second internal electrode 42 is the same as the material of the first internal electrode 41, and is silver and palladium.

The first internal electrode 41 has a rectangular plate shape. The first internal electrode 41 has a principal surface orthogonal to the second axis Y. The second internal electrode 42 has the same rectangular plate shape as the first internal electrode 41. The second internal electrode 42 has a principal surface orthogonal to the second axis Y, similarly to the first internal electrode 41.

The dimension of the first internal electrode 41 in the direction along the first axis X is smaller than the dimension of the base body 20 in the direction along the first axis X. As illustrated in FIG. 1, the dimension of the first internal electrode 41 in the direction along the third axis Z is approximately ⅔ of the dimension of the base body 20 in the direction along the third axis Z. The dimension of the second internal electrode 42 in each direction is the same as that of the first internal electrode 41.

As illustrated in FIG. 3, the first internal electrodes 41 and the second internal electrodes 42 are located in a staggered manner in the direction along the second axis Y. That is, the first internal electrode 41, the second internal electrode 42, the first internal electrode 41, and the second internal electrode 42 are arranged in this order from the side surface 22C facing the second positive direction Y1 toward the second negative direction Y2. In the embodiment, each of the internal electrodes has an equal distance therebetween in the direction along the second axis Y.

As illustrated in FIG. 1, the two first internal electrodes 41 and the two second internal electrodes 42 are both located at the center of the base body 20 in the direction along the third axis Z. On the other hand, as illustrated in FIG. 3, the first internal electrodes 41 are deviated to the first positive direction X1. The second internal electrodes 42 are deviated to the first negative direction X2.

Specifically, the end of the first internal electrode 41 on the first positive direction X1 side coincides with the end of the base body 20 on the first positive direction X1 side. The end of the first internal electrode 41 on the first negative direction X2 side is located inside the base body 20 and does not reach the end of the base body 20 on the first negative direction X2 side. On the other hand, the end of the second internal electrode 42 on the first negative direction X2 side coincides with the end of the base body 20 on the first negative direction X2 side. The end of the second internal electrode 42 on the first positive direction X1 side is located inside the base body 20 and does not reach the end of the base body 20 on the first positive direction X1 side.

The electronic component 10 includes a glass film 50. The glass film 50 covers the outer surface 21 of the base body 20. In the embodiment, the glass film 50 substantially covers the entire region of the outer surface 21 of the base body 20. The main material of the glass film 50 is insulating glass. Therefore, the glass film 50 contains a silicon oxide, specifically, silicon dioxide.

As shown in FIG. 3, the electronic component 10 includes a first external electrode 61 and a second external electrode 62. The first external electrode 61 includes a first underlayer electrode 61A and a first metal layer 61B. The first underlayer electrode 61A is stacked on the glass film 50 in a part including the first end surface 22A in the outer surface 21 of the base body 20. Specifically, the first underlayer electrode 61A is a five-surface electrode that covers the first end surface 22A and a part of the four side surfaces 22C on the first positive direction X1 side in the base body 20. In the embodiment, the material of the first underlayer electrode 61A is copper.

The first metal layer 61B covers the first underlayer electrode 61A from the outside. Thus, the first metal layer 61B is stacked on the first underlayer electrode 61A. Specifically, as illustrated in FIG. 4, the first metal layer 61B has a two-layer structure of a nickel layer 61C and a tin layer 61D. As shown in FIG. 3, the outer edge of the first metal layer 61B is located outside the outer edge of the first underlayer electrode 61A. The outer edge of the first metal layer 61B is located on the surface of the glass film 50. Therefore, a part of the first metal layer 61B is located on the surface of the glass film 50.

As shown in FIG. 3, the second external electrode 62 includes a second underlayer electrode 62A and a second metal layer 62B. The second underlayer electrode 62A is stacked on the glass film 50 in a part including the second end surface 22B in the outer surface 21 of the base body 20. Specifically, the second underlayer electrode 62A is a five-surface electrode that covers the second end surface 22B and a part of the four side surfaces 22C on the first negative direction X2 side in the base body 20. In the embodiment, the material of the second underlayer electrode 62A is the same as the material of the first external electrode 61, and is copper.

The second metal layer 62B covers the second underlayer electrode 62A from the outside. Thus, the second metal layer 62B is stacked on the second underlayer electrode 62A. Specifically, similarly to the first metal layer 61B, the second metal layer 62B has a two-layer structure of a nickel layer and a tin layer, which is not illustrated. As shown in FIG. 3, the outer edge of the second metal layer 62B is located outside the outer edge of the second underlayer electrode 62A. The outer edge of the second metal layer 62B is located on the surface of the glass film 50. Therefore, a part of the second metal layer 62B is located on the surface of the glass film 50.

The second external electrode 62 does not reach the first external electrode 61 on the side surface 22C, and is disposed away from the first external electrode 61 in the direction along the first axis X. On the side surface 22C of the base body 20, the first external electrode 61 and the second external electrode 62 are not stacked and the glass film 50 is exposed in the central portion in the direction along the first axis X. In FIGS. 1 to 3, the first external electrode 61 and the second external electrode 62 are indicated by two-dot chain lines.

As illustrated in FIG. 3, the first external electrode 61 and the end of the first internal electrode 41 on the first positive direction X1 side are connected via a first penetrating portion 71 penetrating the glass film 50. Although details will be described later, the first penetrating portion 71 is formed such that the silver and palladium constituting the first internal electrode 41 extends to the first external electrode 61 side in the manufacturing process of the electronic component 10.

The second external electrode 62 and the end of the second internal electrode 42 on the first negative direction X2 side are connected via a second penetrating portion 72 penetrating the glass film 50. Similarly to the first penetrating portion 71, the second penetrating portion 72 is also formed such that the silver and palladium constituting the second internal electrode 42 extends to the second external electrode 62 side in the manufacturing process of the electronic component 10. In FIG. 3, the first internal electrode 41 and the first penetrating portion 71 are illustrated as separate members having a boundary; however, actually, there is no clear boundary therebetween. In this respect, the same applies to the second penetrating portion 72. In FIGS. 1 and 2, the first penetrating portion 71 and the second penetrating portion 72 are not shown.

### <Glass Film>

The portion of the glass film 50 that is covered with neither the first underlayer electrode 61A nor the second underlayer electrode 62A is a substantially uniform glass layer made of silicon dioxide. On the other hand, the portion of the glass film 50 covered with either the first underlayer electrode 61A or the second underlayer electrode 62A is a mixture of two types of glass layers having different compositions.

Specifically, as illustrated in FIG. 4, the glass film 50 includes a base portion 51 and a specific portion 52. Most of the base portion 51 and the specific portion 52 are located between the first underlayer electrode 61A and the outer surface 21 of the base body 20 and between the second underlayer electrode 62A and the outer surface 21 of the base body 20 in the glass film 50. The base portion 51 contains an oxide of one or more metal elements of an alkali metal and an alkaline earth metal in addition to a silicon oxide. In the embodiment, the metal element is barium. In the embodiment, the base portion 51 contains oxides of barium and calcium among alkaline earth metals. The base portion 51 also contains a zinc oxide. Further, the base portion 51 contains an aluminum oxide.

The specific portion 52 is a flat layer in a section view. The specific portion 52 contains an oxide of the same metal element as that of the base portion 51 in addition to a silicon oxide. In the embodiment, the specific portion 52 contains an oxide of barium among alkaline earth metals. On the other hand, the specific portion 52 does not contain a calcium oxide. The specific portion 52 also contains a zinc oxide. On the other hand, the specific portion 52 does not contain an aluminum oxide.

The content ratio of barium as a metal element in the specific portion 52 is smaller than the content ratio of barium as a metal element in the base portion 51. Furthermore, the content ratio of silicon in the specific portion 52 is larger than the content ratio of silicon in the base portion 51. The content ratio of zinc in the specific portion 52 is larger than the content ratio of zinc in the base portion 51.

### <Method of Manufacturing Electronic Component>

Next, the method of manufacturing the electronic component 10 will be described.

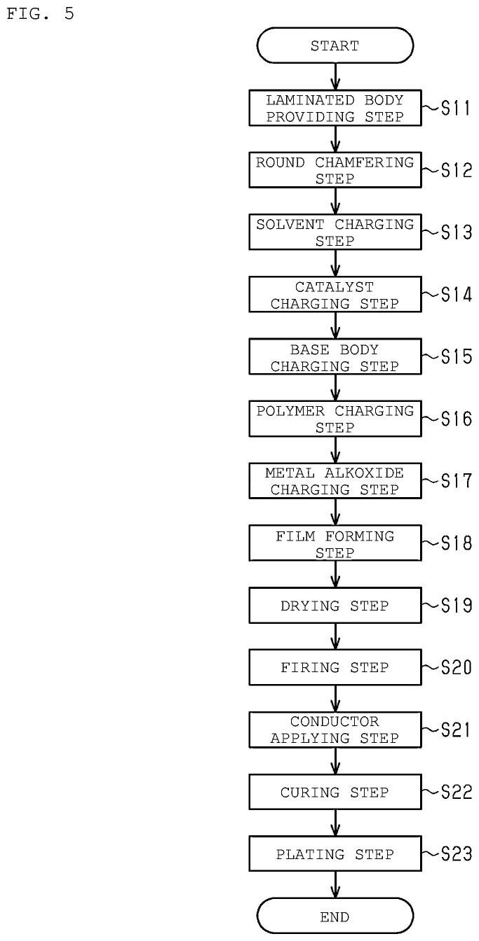

As illustrated in FIG. 5, the method of manufacturing the electronic component 10 includes a laminated body providing step S11, a round chamfering step S12, a solvent charging step S13, a catalyst charging step S14, a base body charging step S15, a polymer charging step S16, and a metal alkoxide charging step S17. The method of manufacturing the electronic component 10 further includes a film forming step S18, a drying step S19, a firing step S20, a conductor applying step S21, a curing step S22, and a plating step S23.

First, when the base body 20 is formed, in the laminated body providing step S11, a laminated body that is the base body 20 not having the boundary surfaces 23 or the corner surfaces 24 is provided. That is, the laminated body is in a state before round chamfering, and has a rectangular parallelepiped shape having the six planar surfaces 22. For example, first, a plurality of ceramic sheets to be the base body 20 are provided. Each of the sheets has a thin plate shape. A conductive paste to be the first internal electrode 41 is stacked on the sheet. A ceramic sheet to be the base body 20 is stacked on the stacked paste. A conductive paste to be the second internal electrode 42 is stacked on the sheet. In this manner, the ceramic sheet and the conductive paste are stacked. Then, an unfired laminated body is formed by cutting into a predetermined size. Thereafter, the unfired laminated body is fired at a high temperature to provide a laminated body.

Next, the round chamfering step S12 is performed. In the round chamfering step S12, the boundary surfaces 23 and the corner surfaces 24 are formed on the laminated body provided in the laminated body providing step S11. For example, a corner of the laminated body is round-chamfered by barrel polishing, whereby the boundary surface 23 having a curved surface and the corner surface 24 having a curved surface are formed. Thus, the base body 20 is formed.

Next, the solvent charging step S13 is performed. As illustrated in FIG. 6, in the solvent charging step S13, 2-propanol is charged as a solvent 82 into a reaction vessel 81.

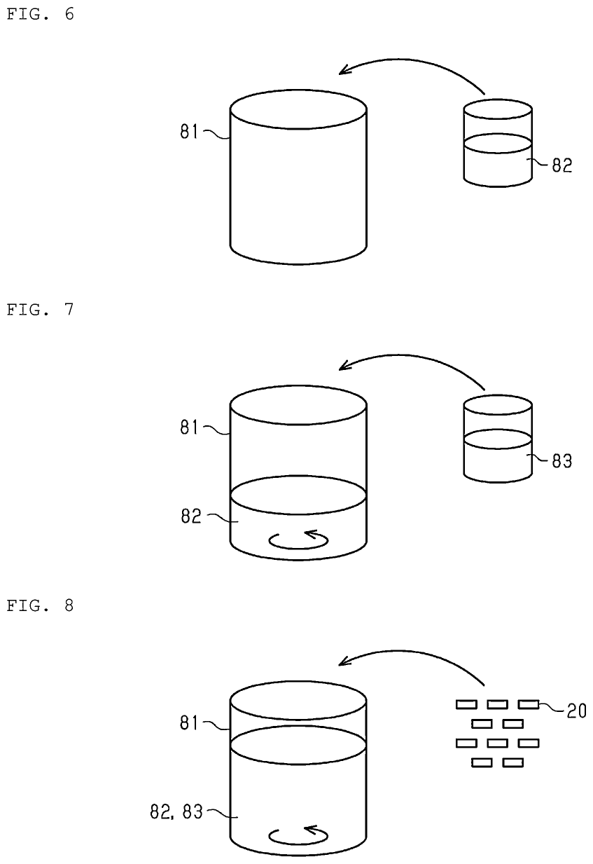

Next, as illustrated in FIG. 5, the catalyst charging step S14 is performed. As illustrated in FIG. 7, in the catalyst charging step S14, first, stirring of the solvent 82 in the reaction vessel 81 is started. Then, ammonia water as an aqueous solution 83 containing a catalyst is charged into the reaction vessel 81. The catalyst in this embodiment is a hydroxide ion, and functions as a catalyst that promotes hydrolysis of a metal alkoxide 85 described later.

Next, as illustrated in FIG. 5, the base body charging step S15 is performed. As illustrated in FIG. 8, in the base body charging step S15, the plurality of base bodies 20 formed in advance in the round chamfering step S12 as described above are charged into the reaction vessel 81.

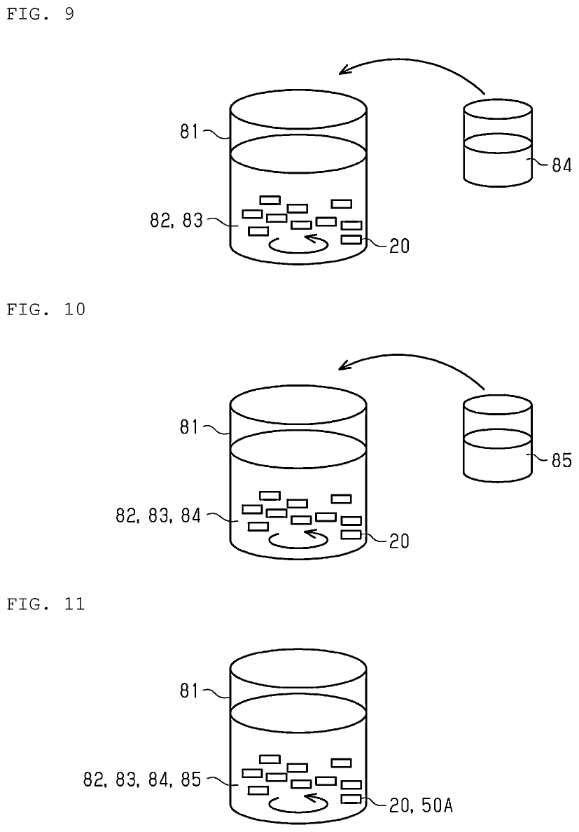

Next, as illustrated in FIG. 5, the polymer charging step S16 is performed. As illustrated in FIG. 9, in the polymer charging step S16, polyvinylpyrrolidone is charged as a polymer 84 into the reaction vessel 81. As a result, the polymer 84 charged into the reaction vessel 81 is adsorbed to the outer surfaces 21 of the base bodies 20.

Next, as illustrated in FIG. 5, the metal alkoxide charging step S17 is performed. As illustrated in FIG. 10, in the metal alkoxide charging step S17, tetraethyl orthosilicate in a liquid state is charged as the metal alkoxide 85 into the reaction vessel 81. Tetraethyl orthosilicate is sometimes referred to as tetraethoxysilane. In the present embodiment, the amount of the metal alkoxide 85 to be charged in the metal alkoxide charging step S17 is calculated based on the area of the outer surface 21 of the base body 20 charged in the base body charging step S15. Specifically, the amount is calculated by multiplying the amount of the metal alkoxide 85 per one base body 20 that is necessary for forming a pre-diffusion glass film 50A covering the outer surface 21 of the base body 20 by the number of base bodies 20. As will be described later, the pre-diffusion glass film 50A is a film in a state before the metal element contained in the glass of the conductor paste diffuses. That is, the pre-diffusion glass film 50A contains no metal element derived from the conductor paste.

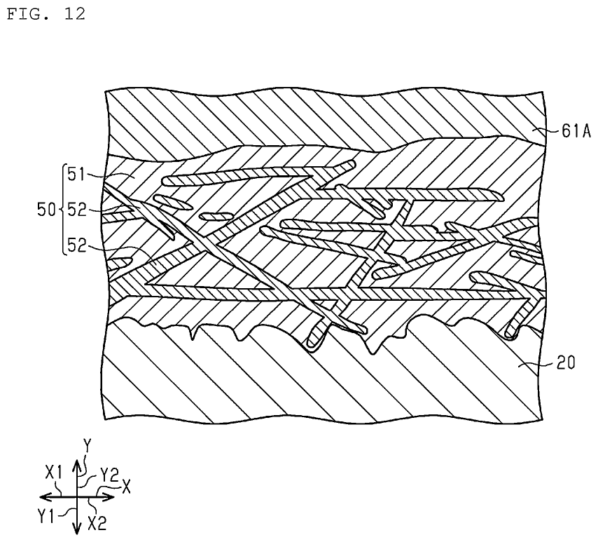

Next, as illustrated in FIG. 5, the film forming step S18 is performed. As illustrated in FIG. 11, in the film forming step S18, the stirring of the solvent 82 started in the solvent charging step S13 described above is continued for a predetermined time after the metal alkoxide 85 is charged into the reaction vessel 81 in the metal alkoxide charging step S17. In the film forming step S18, the pre-diffusion glass film 50A is formed by a liquid phase reaction in the reaction vessel 81.

Next, as illustrated in FIG. 5, the drying step S19 is performed. In the drying step S19, after the stirring is continued for the predetermined time in the film forming step S18, the base body 20 is taken out from the reaction vessel 81 and dried. As a result, the sol-like pre-diffusion glass film 50A is dried to become a gel-like pre-diffusion glass film 50A.

Next, the firing step S20 is performed. In the firing step S20, the base body 20 covered with the gel-like pre-diffusion glass film 50A is heated. As a result, water and the polymer 84 are vaporized from the gel-like pre-diffusion glass film 50A. As a result, the pre-diffusion glass film 50A made of silicon dioxide is formed.

Next, the conductor applying step S21 is performed. In the conductor applying step S21, a conductor paste is applied to two portions of the surface of the pre-diffusion glass film 50A, that is, a portion including a portion covering the first end surface 22A of the base body 20 and a portion including a portion covering the second end surface 22B of the base body 20. Specifically, the conductor paste is applied to cover the glass film 50 on the entire region of the first end surface 22A and a part of the four side surfaces 22C. Furthermore, the conductor paste is applied to cover the pre-diffusion glass film 50A on the entire region of the second end surface 22B and a part of the four side surfaces 22C. The conductor paste contains a copper powder, glass, and an organic medium. The copper powder in the conductor paste becomes the first underlayer electrode 61A and the second underlayer electrode 62A by the subsequent curing step S22. The glass in the conductor paste has an additive containing one or more metal elements of an alkali metal and an alkaline earth metal. More specifically, the metal element is barium. Further, the conductor paste contains calcium, aluminum, and zinc as an additive.

Next, the curing step S22 is performed. Specifically, in the curing step S22, the base body 20 applied with the pre-diffusion glass film 50A and the conductor paste is heated. As a result, the organic medium in the conductor paste is vaporized. Then, the copper powder in the conductor paste is integrated to become the first underlayer electrode 61A and the second underlayer electrode 62A. That is, the material of the first underlayer electrode 61A and the second underlayer electrode 62A is copper. The first underlayer electrode 61A and the second underlayer electrode 62A may contain impurities.

At the same time, the glass in the conductor paste is melted to be integrated with a part of the pre-diffusion glass film 50A. However, the pre-diffusion glass film 50A is made substantially only of a silicon oxide at the start of the curing step S22. Therefore, the pre-diffusion glass film 50A has a high melting point. Therefore, a part of the pre-diffusion glass film 50A is not integrated with the glass in the conductor paste and remains. However, at this time, the metal element contained in the glass additive in the conductor paste is diffused into the pre-diffusion glass film 50A made of silicon dioxide. As a result, the metal element enters the pre-diffusion glass film 50A covering the outer surface 21 of the base body 20. Thereafter, when the base body 20 is fired, the mixture of the glass derived from the conductor paste and the pre-diffusion glass film 50A becomes the base portion 51. On the other hand, the remaining pre-diffusion glass film 50A that has not been integrated with the glass in the conductor paste becomes the specific portion 52. As described above, the metal element is also diffused in the remaining pre-diffusion glass film 50A that has not been integrated with the glass in the conductor paste. Therefore, although in a smaller amount compared with the base portion 51, the specific portion 52 contains a metal element.

In the pre-diffusion glass film 50A, the metal elements are less likely to diffuse as described above in the portion not covered with the conductor paste. Therefore, the portion of the pre-diffusion glass film 50A that is not covered with the conductor paste becomes a substantially uniform glass layer, without being separated into the base portion 51 and the specific portion 52.

In the embodiment, at the time of heating in the curing step S22, silver and palladium contained on the first internal electrode 41 side is drawn toward the first underlayer electrode 61A side, which is copper, due to the Kirkendall effect caused by a difference in diffusion rate between the first internal electrode 41 and the first underlayer electrode 61A. As a result, the first penetrating portion 71 penetrates and extends through the glass film 50 from the first internal electrode 41 toward the first underlayer electrode 61A, so that the first internal electrode 41 and the first underlayer electrode 61A are connected with each other. In this respect, the same applies to the second penetrating portion 72 connecting the second internal electrode 42 and the second underlayer electrode 62A.

Next, the plating step S23 is performed. In the plating step S23, electroplating is performed on portions of the first underlayer electrode 61A and the second underlayer electrode 62A. As a result, the first metal layer 61B is formed on the surface of the first underlayer electrode 61A. In addition, the second metal layer 62B is formed on the surface of the second underlayer electrode 62A. As illustrated in FIG. 4, the first metal layer 61B is electroplated with two kinds, nickel and tin, to have a two-layer structure of a nickel layer 61C and a tin layer 61D. Although not illustrated, similarly to the first metal layer 61B, the second metal layer 62B is electroplated with two kinds, nickel and tin, in this order, to have a two-layer structure of a nickel layer and a tin layer. In this way, the electronic component 10 is formed.

### Action of Embodiment

The electronic component 10 of the embodiment is surface-treated using a water-soluble flux when soldered to a substrate or the like. At this time, the water-soluble flux may enter the inside of the glass film 50 from the interface between the first external electrode 61 and the glass film 50, and further enter the base body 20.

### Effect of Embodiment

(1) According to the embodiment, the glass film 50 includes the base portion 51 and the specific portion 52. The specific portion 52 contains a silicon oxide and a metal element oxide. The content ratio of the metal element in the specific portion 52 is smaller than the content ratio of the metal element in the base portion 51. Therefore, an interface can be present between the base portion 51 and the specific portion 52 in the glass film 50. When the glass film 50 has an interface therein as described above, a water-soluble flux infiltrating into the glass film 50 extends on the interface. Therefore, the infiltrating water-soluble flux hardly permeates deeper than the interface between the base portion 51 and the specific portion 52. Therefore, erosion from the outside to the base body 20 can be further prevented. As described above, according to the embodiment, the flux resistance can be improved without necessarily requiring the addition of a silica powder.

(2) According to the embodiment, the content ratio of silicon in the specific portion 52 is larger than the content ratio of silicon in the base portion 51. As described above, the composition of the specific portion 52 is different from the composition of the base portion 51. Therefore, the interface between the base portion 51 and the specific portion 52 is clearer.

(3) According to the embodiment, the metal element is barium among alkaline earth metals. Barium is relatively easily available among alkaline earth metals. Therefore, it is not necessary to prepare an element that is difficult to obtain.

(4) According to the embodiment, the specific portion 52 contains a zinc oxide. Therefore, by containing zinc, a stable composition containing barium of alkaline earth metal is likely to be obtained.

(5) According to the embodiment, the content ratio of zinc in the specific portion 52 is larger than the content ratio of zinc in the base portion 51. Therefore, the composition of the specific portion 52 is different from the composition of the base portion 51. Therefore, the interface between the base portion 51 and the specific portion 52 is clearer.

(6) According to the embodiment, the first external electrode 61 includes the first metal layer 61B. Therefore, the electronic component 10 is probably used to be mounted on a substrate or the like by solder. In other words, the electronic component 10 is probably exposed to a water-soluble flux. Therefore, the effect of preventing the infiltration of a water-soluble flux is significant.

(7) According to the embodiment, the first metal layer 61B spreads over a wider range than the first underlayer electrode 61A. Therefore, a part of the first metal layer 61B is located on the surface of the glass film 50. Therefore, when the outer edge of the first metal layer 61B is located outside the outer edge of the first underlayer electrode 61A, it is possible to prevent a gap from being formed between the first external electrode 61 and the glass film 50. By preventing such gap from being formed, it is easy to prevent a water-soluble flux from entering from between the first external electrode 61 and the glass film 50.

### OTHER EMBODIMENTS

The embodiment can be modified as follows for implementation. The embodiment and the following modifications can be implemented in combination within a range not technically contradictory.

In the embodiment, the electronic component 10 is not limited to a negative characteristic thermistor component. For example, the electronic component may be a thermistor component other than those having a negative characteristic, a multilayer capacitor component, or an inductor component as long as the inside of the base body 20 is provided with some wiring.

The material of the base body 20 is not limited to the example of the embodiment. The material of the base body 20 may be a composite of a resin and a metal powder.

The shape of the base body 20 is not limited to the example of the embodiment. For example, the base body 20 may have a polygonal columnar shape, other than a quadrangular columnar shape, having a central axis CA. Furthermore, the base body 20 may be the core of a wire-wound inductor component. For example, the core may have what is called a drum core shape. Specifically, the core may have a columnar winding core portion and a flange portion provided at each end of the winding core portion.

The outer surface 21 of the base body 20 does not necessarily have the boundary surface 23 or the corner surface 24. For example, when the boundary between the adjacent planar surfaces 22 of the outer surface 21 of the base body 20 does not have a chamfered shape, there is no curved surface at the boundary. Therefore, in some of such a case, neither the boundary surface 23 nor the corner surface 24 exists.

In the embodiment, the shapes of the first internal electrode 41 and the second internal electrode 42 are not limited as long as they can ensure electrical conduction with the corresponding first external electrode 61 and second external electrode 62. The number of the first internal electrodes 41 and the number of the second internal electrodes 42 are not limited, and the number of the internal electrodes may be one or may be three or more.

The configuration of the first external electrode 61 is not limited to the example of the embodiment. For example, the first external electrode 61 may include only the first underlayer electrode 61A, or the first metal layer 61B does not necessarily have a two-layer structure. In this respect, the same applies to the second external electrode 62.

In the embodiment, the material combination of the first internal electrode 41 and the first underlayer electrode 61A is not limited to the combination of copper for one and silver and palladium for the other. For example, the combination may be palladium and silver, copper and nickel, copper and silver, copper and palladium, silver and gold, nickel and cobalt, or nickel and gold. For example, one may be copper, and the other may be a combination of copper and nickel. For example, one may be nickel, and the other may be a combination of copper and nickel. For example, one may be gold, and the other may be a combination of silver and palladium.

In some combinations of the first internal electrode 41 and the first underlayer electrode 61A, the Kirkendall effect cannot be obtained. In this case, the first internal electrode 41 may be processed to be exposed before the external electrode forming step. For example, a part of the glass film 50 may be physically removed by polishing the first end surface 22A side of the base body 20. Thereafter, the first internal electrode 41 and the first underlayer electrode 61A can be connected by performing the underlayer electrode forming step. Alternatively, for example, after the first underlayer electrode 61A is formed, the glass film 50 may be formed on a region including the surface of the first underlayer electrode 61A, and the glass film 50 covering the surface of the first underlayer electrode 61A may be removed. In this respect, the same applies to the material combination of the second internal electrode 42 and the second underlayer electrode 62A.

The arrangement place of the first external electrode 61 is not limited to the example of the embodiment. For example, the first external electrode 61 may be disposed only on the first end surface 22A and one side surface 22C. In this respect, the same applies to the second external electrode 62.

### <Glass Film>

The glass film 50 does not have to cover the entire region of the outer surface 21 of the base body 20. The range covered with the glass film 50 may be appropriately changed in accordance with the shape of the base body 20, the positions of the first external electrode 61 and the second external electrode 62, and the like.

The metal element contained in the glass film 50 may be an alkali metal. The metal element contained in the glass film 50 may be any of lithium, sodium, and potassium among alkali metals. Incidentally, lithium, sodium, and potassium are relatively easily available among alkali metals. Therefore, it is not necessary to prepare an element that is difficult to obtain.

The metal element contained in the glass film 50 may be calcium among alkaline earth metals. The metal contained in the glass film 50 may be another metal among alkaline earth metals.

The specific portion 52 may contain an aluminum oxide. The specific portion 52 may contain a zinc oxide. In addition, the base portion 51 and the specific portion 52 may contain an additive of other elements. Depending on the content ratio of other elements, the content ratio of silicon in the specific portion 52 may be equal to or less than the content ratio of silicon in the base portion 51.

The base portion 51 does not have to contain an aluminum oxide. The base portion 51 does not have to contain a zinc oxide. Furthermore, the content ratio of zinc in the specific portion 52 may be equal to or less than the content ratio of zinc in the base portion 51.

The material of the glass film 50 is not limited to the example of the embodiment. For example, the glass is not limited to silicon dioxide, and may be a multicomponent oxide containing Si, such as a B—Si-based, Si—Zn-based, Zr—Si-based, or Al—Si-based oxide. Further, the glass may be a multicomponent oxide containing an alkali metal and Si, such as an Al—Si-based, Na—Si-based, K—Si-based, or Li—Si-based oxide. Furthermore, the glass may be a multicomponent oxide containing an alkaline earth metal and Si, such as a Mg—Si-based, Ca—Si-based, Ba—Si-based, or Sr—Si-based oxide. The glass does not have to contain Si, and may be a mixture thereof. When the material of the glass film 50 contains boron, the specific portion 52 may contain a boron oxide. In this case, the base portion 51 may contain a boron oxide.

The material of the glass film 50 may contain a pigment, a silicone-based flame retardant, a surface treatment agent such as a silane coupling agent or a titanate coupling agent, or an antistatic agent in addition to glass.

More specifically, the glass film 50 may contain additives of an organic acid salt, an oxide, an inorganic salt, an organic salt, and other fine particles or nanoparticles of a metal oxide in addition to glass.

Examples of the organic acid salt include salts of oxo acids such as soda ash, sodium carbonate, sodium hydrogen carbonate, sodium percarbonate, sodium sulfite, sodium hydrogen sulfite, sodium sulfate, sodium thiosulfate, sodium nitrate, and sodium sulfite, and halogen compounds such as sodium fluoride, sodium chloride, sodium bromide, and sodium iodide.

Examples of the oxide include sodium peroxide, and examples of the hydroxide include sodium hydroxide.

Examples of the inorganic salt include sodium hydride, sodium sulfide, sodium hydrogen sulfide, sodium silicate, trisodium phosphate, sodium borate, sodium borohydride, sodium cyanide, sodium cyanate, and sodium tetrachloroaurate.

Examples of the inorganic salt include calcium peroxide, calcium hydroxide, calcium fluoride, calcium chloride, calcium bromide, calcium iodide, calcium hydride, calcium carbide, and calcium phosphide.

The additive may be an oxoacid salt such as calcium carbonate, calcium hydrogen carbonate, calcium nitrate, calcium sulfate, calcium sulfite, calcium silicate, calcium phosphate, calcium pyrophosphate, calcium hypochlorite, calcium chlorate, calcium perchlorate, calcium bromate, calcium iodate, calcium arsenite, calcium chromate, calcium tungstate, calcium molybdate, calcium magnesium carbonate, or hydroxyapatite. Examples of the additive include calcium acetate, calcium gluconate, calcium citrate, calcium malate, calcium lactate, calcium benzoate, calcium stearate, and calcium aspartate.

For example, the additive may be lithium carbonate, lithium chloride, lithium titanate, lithium nitride, lithium peroxide, lithium citrate, lithium fluoride, lithium hexafluorophosphate, lithium acetate, lithium iodide, lithium hypochlorite, lithium tetraborate, lithium bromide, lithium nitrate, lithium hydroxide, lithium aluminum hydride, lithium triethylborohydride, lithium hydride, lithium amide, lithium imide, lithium diisopropylamide, lithium tetramethylpiperide, lithium sulfide, lithium sulfate, lithium thiophenolate, or lithium phenoxide.

For example, the additive may be boron triiodide, sodium cyanoborohydride, sodium borohydride, tetrafluoroboric acid, triethylborane, borax, or boric acid.

For example, the additive may be potassium arsenide, potassium bromide, potassium carbide, potassium chloride, potassium fluoride, potassium hydride, potassium iodide, potassium triiodide, potassium azide, potassium nitride, potassium superoxide, potassium ozonide, potassium peroxide, potassium phosphide, potassium sulfide, potassium selenide, potassium telluride, potassium tetrafluoroaluminate, potassium tetrafluoroborate, potassium tetrahydroborate, potassium methanide, potassium cyanide, potassium formate, potassium hydrogen fluoride, potassium tetraiodomercurate (II), potassium hydrogen sulfide, potassium octachlorodimolybdate (II), potassium amide, potassium hydroxide, potassium hexafluorophosphate, potassium carbonate, potassium tetrachloroplatinate (II), potassium hexachloroplatinate (IV), potassium nonahydridorhenate (VII), potassium sulfate, potassium acetate, gold (I) potassium cyanide, potassium hexanitritocobaltate (III), potassium hexacyanoferrate (III), potassium hexacyanoferrate (II), potassium methoxide, potassium ethoxide, potassium tert-butoxide, potassium cyanate, potassium fulminate, potassium thiocyanate, potassium aluminum sulfate, potassium aluminate, potassium arsenate, potassium bromate, potassium hypochlorite, potassium chlorite, potassium chlorate, potassium perchlorate, potassium carbonate, potassium chromate, potassium dichromate, potassium tetrakis (peroxo) chromate (V), potassium cuprate (III), potassium ferrate, potassium iodate, potassium periodate, potassium permanganate, potassium manganate, potassium hypomanganate, potassium molybdate, potassium nitrite, potassium nitrate, tripotassium phosphate, potassium perrhenate, potassium selenate, potassium silicate, potassium sulfite, potassium sulfate, potassium thiosulfate, potassium disulfite, potassium dithionate, potassium disulfate, potassium peroxodisulfate, potassium dihydrogenarsenate, dipotassium hydrogen arsenate, potassium hydrogen carbonate, potassium dihydrogen phosphate, dipotassium hydrogen phosphate, potassium hydrogen selenate, potassium hydrogen sulfite, potassium hydrogen sulfate, or potassium hydrogen peroxosulfate.

For example, the additive may be barium sulfite, barium chloride, barium chlorate, barium perchlorate, barium peroxide, barium chromate, barium acetate, barium cyanide, barium bromide, barium oxalate, barium nitrate, barium hydroxide, barium hydride, barium carbonate, barium iodide, barium sulfide, or barium sulfate. In addition, the additive may be sodium acetate or sodium citrate.

The additive may be fine particles or nanoparticles of a metal oxide, and examples of the metal oxide include sodium oxide, calcium oxide, lithium oxide, boron oxide, potassium oxide, barium oxide, silicon oxide, titanium oxide, zircon oxide, aluminum oxide, zinc oxide, and magnesium oxide.

The specific portion 52 is not limited to one layer. A plurality of the specific portions 52 may be included. The shape of the specific portion 52 does not have to be a layer. For example, in the modification illustrated in FIG. 12, the glass film 50 includes a plurality of specific portions 52. In a section view at a planar surface orthogonal to the outer surface 21 of the base body 20, the major axis of the specific portion 52 is three times or more as long as the minor axis thereof. In a section view, the maximum length among lengths of line segments that pass through the geometric center of one specific portion 52 and are drawn from an outer edge to an outer edge is defined as the major axis. The minor axis is a length of a line segment that passes through the geometric center of the same specific portion 52, is orthogonal to the major axis, and is drawn from an outer edge to an outer edge. That is, according to the modification illustrated in FIG. 12, a plurality of the specific portions 52 increases the number of interfaces between the base portion 51 and the specific portion 52. The major axis of one specific portion 52 is three times or more as long as the minor axis thereof, that is, the specific portion 52 has a plate shape or a needle shape in a section view. Therefore, it is possible to include a complicated passage passing through the base portion 51 from the outside of the glass film 50 to the base body 20. In addition, it is highly possible that more interfaces are arranged in the direction orthogonal to the outer surface 21 of the base body 20.

In the method of manufacturing the electronic component 10, the metal alkoxide 85 may be, for example, sodium methoxide, sodium ethoxide, calcium diethoxide, lithium isopropoxide, lithium ethoxide, lithium tert-butoxide, lithium methoxide, boron alkoxide, potassium t-butoxide, tetraethyl orthosilicate, allyltrimethoxysilane, isobutyl (trimethoxy) silane, tetrapropyl orthosilicate, tetramethyl orthosilicate, [3-(diethylamino) propyl]trimethoxysilane, triethoxy (octyl) silane, triethoxyvinylsilane, triethoxyphenylsilane, trimethoxyphenylsilane, trimethoxymethylsilane, butyltrichlorosilane, n-propyltriethoxysilane, methyltrichlorosilane, dimethoxy (methyl) octylsilane, dimethoxydimethylsilane, tris (tert-butoxy) silanol, tris (tert-pentoxy) silanol, hexadecyltrimethoxysilane, dipotassium tris (1,2-benzenediolato-O,O′) silicate, tetrabutyl orthosilicate, aluminum silicate, calcium silicate, a tetramethylammonium silicate solution, chlorotriisopropoxytitanium (IV), titanium (IV) isopropoxide, titanium (IV) 2-ethylhexyl oxide, titanium (IV) ethoxide, titanium (IV) butoxide, titanium (IV) tert-butoxide, titanium (IV) propoxide, titanium (IV) methoxide, zirconium (IV) bis (diethyl citrato) dipropoxide, zirconium (IV) dibutoxide (bis-2,4-pentanedionate), zirconium (IV) 2-ethylhexanoate, a zirconium (IV) isopropoxide isopropanol complex, zirconium (IV) ethoxide, zirconium (IV) butoxide, zirconium (IV) tert-butoxide, zirconium (IV) propoxide, aluminum tert-butoxide, aluminum isopropoxide, aluminum ethoxide, aluminum-tri-sec-butoxide, or aluminum phenoxide.

In the method of manufacturing the electronic component 10, a metal complex or acetate as a precursor of the metal alkoxide 85 may be used instead of the metal alkoxide 85. In this case, in the metal alkoxide charging step S17, the metal complex or acetate as the metal alkoxide precursor only needs to be charged. Examples of the metal complex include acetylacetonates such as lithium acetylacetonate, titanium (IV) oxyacetylacetonate, titanium diisopropoxide bis (acetylacetonate), zirconium (IV) trifluoroacetylacetonate, zirconium (IV) acetylacetonate, aluminum acetylacetonate, aluminum (III) acetylacetonate, calcium (II) acetylacetonate, and zinc (II) acetylacetonate. Examples of the acetate include zirconium acetate, zirconium (IV) acetate hydroxide, and basic aluminum acetate.

The method of manufacturing the electronic component 10 is not limited to the example of the embodiment. For example, the solvent charging step S13 may be performed after the catalyst charging step S14 or the base body charging step S15. The solvent 82 is not limited to 2-propanol. The solvent 82 may be appropriately changed as long as the metal alkoxide 85 can be sufficiently dispersed.

Technical ideas that can be derived from the embodiments and modifications will be described below.

<1> An electronic component including: a base body; a glass film covering an outer surface of the base body; and an external electrode on an outer surface of the glass film and having at least an underlayer electrode, wherein the glass film includes: a base portion containing silicon oxide and an oxide of one or more metal elements of an alkali metal and an alkaline earth metal; and a specific portion containing silicon oxide and an oxide of a same metal element as that of the base portion, and wherein a content ratio of the same metal element in the specific portion is smaller than a content ratio of the one or more metal elements in the base portion.

<2> The electronic component according to <1>, in which a content ratio of silicon in the specific portion is larger than a content ratio of silicon in the base portion.

<3> The electronic component according to <1> or <2>, in which the one or more metal elements are any of lithium, sodium, and potassium.

<4> The electronic component according to <1> or <2>, in which the one or more metal elements are any of calcium and barium.

<5> The electronic component according to any one of <1> to <4>, in which the specific portion contains an oxide of any element of zinc, boron, and aluminum.

<6> The electronic component according to <5>, in which the base portion contains a zinc oxide, the specific portion contains a zinc oxide, and a content ratio of zinc in the specific portion is larger than a content ratio of zinc in the base portion.

<7> The electronic component according to any one of <1> to <6>, in which the glass film has a plurality of the specific portions, and when in a section view, a maximum length among lengths of line segments that pass through a geometric center of the specific portion and are drawn from an outer edge to an outer edge is defined as a major axis, and in the section view, a length of a line segment that passes through the geometric center of the specific portion, is orthogonal to the major axis, and is drawn from a first outer edge to a second outer edge, is defined as a minor axis, the major axis is three times or more as long as the minor axis.

<8> The electronic component according to any one of <1> to <7>, in which the external electrode further includes a metal layer on a surface of the underlayer electrode.

<9> The electronic component according to <8>, in which a part of the metal layer is on the outer surface of the glass film.

### DESCRIPTION OF REFERENCE SYMBOLS

10: Electronic component
20: Base body
21: Outer surface
50: Glass film
51: Base portion
52: Specific portion
61: First external electrode
61A: First underlayer electrode
61B: First metal layer

1. An electronic component comprising:
a base body;
a glass film covering an outer surface of the base body; and
an external electrode on an outer surface of the glass film and having at least an underlayer electrode, wherein
the glass film includes:
a base portion containing silicon oxide and an oxide of one or more metal elements of an alkali metal and an alkaline earth metal; and
a specific portion containing silicon oxide and an oxide of a same metal element as that of the base portion, wherein
a content ratio of the same metal element in the specific portion is smaller than a content ratio of the one or more metal elements in the base portion.

2. The electronic component according to claim 1, wherein a content ratio of silicon in the specific portion is larger than a content ratio of silicon in the base portion.

3. The electronic component according to claim 1, wherein the one or more metal elements are any of lithium, sodium, and potassium.

4. The electronic component according to claim 1, wherein the one or more metal elements are any of calcium and barium.

5. The electronic component according to claim 1, wherein the specific portion contains an oxide of any element of zinc, boron, and aluminum.

6. The electronic component according to claim 5, wherein
the base portion contains a zinc oxide,
the specific portion contains a zinc oxide, and
a content ratio of zinc in the specific portion is larger than a content ratio of zinc in the base portion.

7. The electronic component according to claim 1, wherein
the glass film has a plurality of the specific portions, and
when,
in a section view, a maximum length among lengths of line segments that pass through a geometric center of the specific portion and are drawn from an outer edge to an outer edge is defined as a major axis, and
in the section view, a length of a line segment that passes through the geometric center of the specific portion, is orthogonal to the major axis, and is drawn from a first outer edge to a second outer edge, is defined as a minor axis,
the major axis is three times or more as long as the minor axis.

8. The electronic component according to claim 1, wherein the external electrode further includes a metal layer on a surface of the underlayer electrode.

9. The electronic component according to claim 8, wherein a part of the metal layer is on the outer surface of the glass film.

10. The electronic component according to claim 1, wherein the base portion further contains a zinc oxide.

11. The electronic component according to claim 1, wherein the base portion further contains an aluminum oxide.

12. The electronic component according to claim 1, wherein the specific portion does not contain a calcium oxide.

13. The electronic component according to claim 1, wherein the specific portion further contains a zinc oxide.

14. The electronic component according to claim 1, wherein the specific portion does not contain an aluminum oxide.

15. The electronic component according to claim 1, wherein
the base portion further contains a zinc oxide and an aluminum oxide,
the specific portion further contains a zinc oxide, and
the specific portion does not contain a calcium oxide or an aluminum oxide.
